(19) United States
(12) Patent Application Publication
(10) Pub. No.: US 2002/0197732 A1
(43) Pub. Date: Dec. 26, 2002

(54) Method and apparatus for combinatorial screening of polymer compositions

(76) Inventors: James Claude Carnahan, Niskayuna, NY (US); James Edward Pickett, Niskayuna, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,879

(22) Filed: Jun. 20, 2001

(51) Int. Cl. G01N 21/76

(52) U.S. Cl. 436/172; 422/52

(57) ABSTRACT

A method and apparatus for detecting chemiluminescence from polymer samples at various temperatures are described. The method enables rapid parallel determination of the heat-stability, light-stability, and oxidative stability of polymer samples as a function of their composition. The method is particularly useful for determining the stability of polymer compositions forming combinatorial libraries.

### BACKGROUND OF INVENTION

The present invention relates to an apparatus and method for determining the properties of polymer compositions. In particular, the invention relates to an apparatus and method for rapidly determining the properties of a large number of polymer compositions.

The use of chemiluminescence to study the oxidative stability of polymer compositions is known. For example, Ashby described the chemiluminescence of polypropylene in an oxygen-containing atmosphere and noted that the emission intensity was related to the concentration of oxygen in contact with the polymer surface (G. E. Ashby, Journal of Polymer Science, volume 50, pages 99-106 (1961)). Apparatuses for studying the oxidative stability of polymeric compositions have been described in, for example, U.S. Pat. Nos. 4,350,495 to Broutman et al., and 5,818,599 to Plavnik et al.

Continuing efforts to discover new polymer compositions may utilize combinatorial chemistry methods that generate many samples in a short period of time. Known chemiluminescence methods for predicting polymer properties are too slow to be practical for the analysis of the many samples constituting a combinatorial library of polymer compositions. There is therefore a need for a rapid method of chemiluminescence analysis of polymeric compositions.

### SUMMARY OF INVENTION

A method for the rapid analysis of polymeric compositions comprises:

detecting a chemiluminescent characteristic from each of a plurality of analytical samples, wherein at least one of the analytical samples comprises a composition comprising a non-biological organic polymer; and

determining a property of the composition based on the chemiluminescent characteristic.

### BRIEF DESCRIPTION OF DRAWINGS

FIG. 1 is a schematic representation of an analytical system comprising a temperature controller, a chemiluminescence detector, and a computer.

FIG. 2 is a schematic representation of an analytical system comprising, in addition to the components shown in FIG. 1, a fiber-coupling lens array, a plurality of optical fibers, and a fiber array-detector interface.

FIG. 3 is a top view of a fiber array-detector interface for a 96-sample array.

FIG. 4 is a schematic diagram illustrating three embodiments of a sample array comprising a continuous film of the polymer composition.

FIG. 5 is a schematic diagram of a sample array in which each analytical sample is oriented to direct chemiluminescent emissions toward a unique region of the detector.

### DETAILED DESCRIPTION

A method for the analysis of polymeric compositions comprises:detecting a chemiluminescent characteristic from each of a plurality of analytical samples, wherein at least one of the analytical samples comprises a composition comprising a non-biological organic polymer; and determining a property of the composition based on the chemiluminescent characteristic.

The chemiluminescent characteristic detected from each analytical sample may be any function comprising the intensity of the chemiluminesce from that sample, including the time to detectable light output, the time to peak light output, the magnitude of peak light output, the best-fit linear slope of light output versus time, the integrated area of light output versus time, and the like.

There is no particular limitation on the detector used to detect the chemiluminescent emissions from the plurality of analytical samples. In one embodiment, the analytical system comprises a single detector capable of detecting the emission from one analytical sample at a time. Suitable detectors for this purpose include, for example, photomultiplier tubes and avalanche photodiodes. In another embodiment, the analytical system comprises at least four, preferably at least nine, more preferably at least 25, detection elements for each of the analytical samples making up the plurality of analytical samples. In another, highly preferred, embodiment, the detector comprises an array detector capable of simultaneously detecting the emission from at nine, preferably at least 25, more preferably at least 96 analytical samples. The number of analytical samples simultaneously detected may also be expressed as a fraction of the plurality of analytical samples on a given sample array. In that case, it is preferred that the detector be capable of simultaneously detecting the chemiluminescent emission from at least about 10% of the plurality analytical samples, more preferably at least about 25%, yet more preferably at least about 50%, still more preferably substantially all of the analytical samples. Suitable array detectors include charge-coupled devices (CCDs), charge-injection devices (CIDs), complementary metal oxide semiconductors (CMOS) devices, photodiode arrays, and photodetector arrays. Presently preferred array detectors include cooled CCDs, in which the temperature of the sensor may be maintained at about −200° C. to about 0° C. to minimize dark current and thereby increase sensitivity.

The detector may also comprise a photographic film sensitive to the chemiluminescent emission. Suitable photographic films include high speed black and white films supplied by Eastman Kodak, Ilford, and others. Exposures may be for fixed intervals and a series of exposures over the experiment time would be obtained and developed using processes that enhance the sensitivity of the emulsion. The developed image from such a film may be scanned to yield an electronic image file equivalent to that obtained from an array sensor.

There is no particular limitation on the time over which the chemiluminescent emissions are integrated. The integration times are typically about 1 second to about 1 hour, with integration times of about 1 second to about 15 minutes being more common. In general, the integration times will depend on the intensity of the chemiluminescent emissions and will be sufficiently long to enable detection of at least 10 photons per detection element.

The plurality of analytical samples is herein defined as comprising at least four samples, preferably at least about 25 samples, more preferably at least about 48 samples, yet more preferably at least about 96 samples. The number of analytical samples comprising the plurality may be much greater. For example, U.S. Pat. No. 5,854,684 to Stabile et al. describes analytical matrices comprising at least one million samples arranged in a density of at least about 10 sites per square centimeter, and U.S. Pat. No. 5,840,256 to Demers et al. provides details for a 7.25 square inch analytical matrix comprising 99,856 samples. Microscale reaction vessels and methods of delivering reagents to them are described in, for example, U.S. Pat. Nos. 5,846,396 to Zanzucchi et al., 5,985,356 to Schultz et al., and 6,045,671 to Wu et al.; and PCT International Application No. WO 2000/09255 to Turner et al. Generally, each analytical site may comprise about 1.0 nanogram to about 100 milligrams, preferably about 500 micrograms to about 50 milligrams, and more preferably about 1 milligram to about 30 milligrams of a polymer composition.

In a preferred embodiment, the plurality of analytical samples is contained within a sample array having opaque walls separating samples. This improves the ability to resolve chemiluminescence from each sample. The opaque wall may comprise a reflective coating, preferably a reflective coating comprising a metallic element, such as aluminum, silver, gold, nickel, palladium, platinum, copper, or an alloy comprising at least one of the foregoing elements. The sample array may be fabricated completely from an opaque material, preferably a reflectively opaque material.

In a preferred embodiment, the plurality of samples is contained within a sample array comprising a sample array cover. The sample array cover may be, for example, a transparent cover without lens elements. Alternatively, the sample array cover may comprise a lens array comprising a plurality of lenses, such as ball lenses. Lenses, including ball lenses, may collectively form a monolithic lens array. The lenses may direct light toward the detector, directly or via a fiber optic array. Suitable lens arrays, including ball lens arrays and monolithic lens arrays are known in the art and described in, for example, U.S. Pat. Nos. 4,968,148 and 5,112,134 to Chow et al.

In a preferred embodiment, the method utilizes lens arrays with optical fibers to operably couple each lens element to a detector. The lens elements may be associated with each fiber as a unit or the fibers may be arranged to address the lens elements in a monolithic lens array. The detector operably coupled to each fiber optic cable may be either an individual sensor, such as a photomultiplier tube, or a unique region of an array sensor. A fiber array-detector interface may be used to operably couple the optical fiber to the detector. The interface may be an arrangement of the detector ends of the fibers in an array that permits correlation of the source location to the detector end location. In a preferred embodiment, the detector end of the fibers will be arranged in a spatially reduced array of the same geometric arrangement as the sample array. The interface can, for example, be coupled directly to the image detector, or it may be coupled to the image detector via a separate lens system. Suitable optical fibers, including tapered fiber optic cables, include fused silica or glass fibers known to those skilled in the art and commercially available from, for example, Corning. Methods for operably coupling optical fibers to lenses and detectors are described in, for example, U.S. Pat. Nos. 4,968,148 and 5,112,134 to Chow et al.

In one embodiment, a sample array comprises wells arranged to focus light emitted from each analytical sample onto a unique area of an array detector. In this embodiment, the walls of each well are parallel to a line connecting the center bottom of the well and the unique area of the detector. The detector may employ a lens, such as, for example, a telecentric lens, to gather and focus light from the sample array.

At least one of the analytical samples comprises a polymeric composition. Preferably at least about 50 percent, more preferably at least about 75 percent, yet more preferably at least about 90 percent, of the analytical samples comprise a polymeric composition. In some cases, it may be useful to include control analytical samples that do not comprise a polymeric composition. For example, one or more analytical samples free of any chemiluminescent material may be used as a reference for polymer-containing samples. The polymeric composition may be homogeneous or heterogeneous, and it may comprise more than one polymeric component. It is preferred that the polymeric composition comprises a non-biological organic polymer. A non-biological organic polymer does not comprise a polymerization product of (a) alpha- or beta-amino acids; (b) nucleic acids, including ribonucleic acids and deoxyribonucleic acids; or (c) saccharides, including mono- and disaccharides. The definition of non-biological organic polymer thus expressly excludes DNA, RNA, polysaccharides, and proteins derived from naturally occurring alpha-amino acids.

Non-biological organic polymers include thermoplastic resins and thermosetting resins. Non-limiting examples of thermoplastic resins include, for example, polyethylene, polypropylene, polyisoprene, polysiloxanes, polyolefins including linear low density polyolefins, acrylate polymers, methacrylate polymers, poly(alkylene oxides) polymers, poly(vinyl chloride), poly(vinylidene chloride), poly (tetrafluoroethylene), polycarbonate resins, polyphenylene ether resins, polyphenylene sulfide resins, poly(alkylene aromatic) resins, vinyl aromatic graft copolymers resins, polyester resins, polyamide resins, polyesteramide resins, polysulfone resins, polyimide resins, polyetherimide resins, styrene copolymers including acrylonitrile butadiene styrene copolymers, poly(ethylene-vinylacetate), blends and alloys comprising at least one of the foregoing thermoplastic resin, and the like. Non-limiting examples of thermoset resins include, for example, epoxy resins, phenolic resins, alkyds, allylic resins, polyester thermosetting resins, polyimide thermosetting resins, polyurethane resins, bis-maleimide resins, cyanate ester resins, vinyl resins, benzoxazine resins, benzocyclobutene resins, mixtures comprising at least one of the foregoing thermosetting resins, and the like. Highly preferred non-biological organic polymers include polypropylene, polyethylene, ethylene-propylene copolymers, poly(ethylene-vinylacetate), polycarbonates, polyesters, polyamides, polyetherimides, polyphenylene ethers, polyphenylene sulfides, poly(alkylene aromatic) polymers, acrylonitrile butadiene styrene copolymers, acrylic styrene acrylonitrile copolymers, mixtures comprising at least one of the foregoing polymers, and the like. A presently preferred non-biological polymer is a polypropylene.

In a preferred embodiment, the composition is a polymer blend, comprising at least two of the non-biological polymers described above. In addition to at least one non-biological polymer, the composition may comprise at least one additive. Suitable additives may be any known additive, including antioxidants, stabilizers, metal deactivators, ultraviolet (UV) light absorbers, fillers and reinforcing agents, flame retardants, mold release agents, and the like. These and other additives are known in the art and described in, for example, Plastics Additives, 4^{th} Ed., R. G ä chter and H. M ü ller, eds., Hansen Publishers (1993) and in Modern Plastics World Encyclopedia 2000, pages B2-B142.

Suitable antioxidants include organophosphites, for example, tris(nonylphenyl)phosphite, tris(2,4-di-t-butylphenyl)phosphite, bis(2,4-di-t-butylphenyl) pentaerythritol diphosphite, and distearyl pentaerythritol diphosphite, organophosphonites such as SANDOSTAB ® P-EPQ manufactured by Sandoz Japan Co. Ltd, alkylated monophenols, polyphenols and alkylated reaction products of polyphenols with dienes, such as, for example, tetrakis[methylene(3,5-di-tert-butyl-4-hydroxyhydrocinnamate)]methane, 3,5-di-tert-butyl-4-hydroxyhydrocinnamate octadecyl, 2,4-di-tert-butylphenyl phosphite, butylated reaction products of para-cresol and dicyclopentadiene, alkylated hydroquinones, hydroxylated thiodiphenyl ethers, alkylidene-bisphenols, benzyl compounds, esters of beta-(3,5-di-tert-butyl-4-hydroxyphenyl)-propionic acid with monohydric or polyhydric alcohols, esters of beta-(5-tert-butyl-4-hydroxy-3-methylphenyl)-propionic acid with monohydric or polyhydric alcohols; esters of thioalkyl or thioaryl compounds, such as, for example, distearylthiopropionate, dilaurylthiopropionate, ditridecylthiodipropionate; amides of beta-(3,5-di-tert-butyl-4-hydroxyphenyl)-propionic acid; and the like.

Suitable ultraviolet light absorbers include resorcinol derivatives, such as 4,6-dibenzoyl-2-(3-triethoxysilylpropyl)resorcinol, as well as the hindered amine light stabilizers (HALS), including 2,2,6,6-tetramethyl piperidinol, TINUVIN ® 123 (Ciba-Geigy), and SANDUVOR ® 3058 (Clariant).

Suitable fillers and reinforcing agents include, for example, silicates, titanium dioxide metal fibers, glass fibers (including continuous and chopped fibers), carbon fibers including vapor grown carbon fibers and fibrils and nanotubes, carbon black, graphite, calcium carbonate, talc, mica, and the like. Particularly preferred vapor-grown carbon fibers include those having an average diameter of about 3.5 to about 500 nanometers as described in, for example, U.S. Pat. Nos. 4,565,684 and 5,024,818 to Tibbetts et al.; 4,572,813 to Arakawa; 4,663,230 and 5,165,909 to Tennent; 4,816,289 to Komatsu et al.; 4,876,078 to Arakawa et al.; 5,589,152 to Tennent et al.; and 5,591,382 to Nahass et al.

Suitable flame retardants include halogenated materials, organic phosphate esters, and mixtures comprising either or both. Halogenated materials include, for example, 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dichromophenyl)-hexane; bis-(4-chlorophenyl)-phenyl-methane; bis-(3,5-dichlorophenyl)-cyclohexylmethane; bis(3-nitro-4-bromophenyl)-methane; bis-(4-hydroxy-2,6-dichloro-3-methoxyphenyl)-methane; 2,2-bis-(3,5-dichloro-4-hydroxyphenyl)-propane 2,2 bis-(3-bromo-4-hydroxyphenyl)-propane, and the like. Organic phosphates include, for example, phenyl bisdodecyl phosphate, phenylbisneopentyl phosphate, phenyl-bis (3,5,5′-tri-methyl-hexyl phosphate), ethyldiphenyl phosphate, 2-ethyl-hexyldi(p-tolyl) phosphate, bis-(2-ethylhexyl) p-tolylphosphate, tritolyl phosphate, bis-(2-ethylhexyl) phenyl phosphate, tri-(nonylphenyl) phosphate, di (dodecyl) p-tolyl phosphate, tricresyl phosphate, triphenyl phosphate, dibutylphenyl phosphate, 2-chloroethyldiphenyl phosphate, p-tolyl bis(2,5,5′-trimethylhexyl) phosphate, 2-ethylhexyldiphenyl phosphate, resorcinol tetraphenyl diphosphate, bis-phenol A tetraphenyl diphosphate,and the like.

Suitable lubricants and mold release agents include, for example, alkanes having about 14 to about 60 carbon atoms, such as hexadecane (C₁₆), octadecane (C₁₈), decosane (C₂₂), octacosane (C₂₈), hexatricontane (C₃₆), tetratetracontane (C₄₄), and hexapentacontane (C₅₆); alpha olefins such as butadecene-1, octadecene-1, hexatricontene-1 (C₃₆) tetracontene-1 (C₄₀) and tetratetracontene-1 (C₄₄),5-n-propyltricontene-1 (C), 2,6-dimethyleicosene-1 (C₄₄), and 4-methyl-12-ethyltetracontene-1 (C₄₃); internal olefins such as butadecene-3, octacosene-7, hexatricontene-12, 4-ethyleneyleicosane (C₂₂) and 2,10-dimethyltetracontene-6; saturated and unsaturated normal fatty acids having about 14 to about 36 carbon atoms, such as myristic, palmitic, stearic, arachidic, behenic, hexatrieisocontanoic (C₃₆), palmitoleic, oleic, linolenic and cetoleic acids, and the like; vinyl ethers of alkyl groups having about 14 to about 36 carbon atoms; esters and partial esters of saturated aliphatic carboxylic acids having about 10 to about 20 carbon atoms and aliphatic 4-hydric to 6-hydric alcohols, such as pentaerythritol tetrastearate, pentaerythritol tetrapalmitate, pentaerythritol tetramyristate, pentaerythritol tetralaurate, mesoerythritol tetralaurate, mesoerythritol tetrastearate, mesoerythritol tetramargaric acid ester, mesoerythritol tetramyristate, mesoerythritol tetraeicosate, xylitol pentastearate, xylitol pentatridecanoic acid ester, xylitol pentapalmitate, arabitol pentastearate, arabitol pentapalmitate, sorbitol hexastearate, sorbitol hexapentaacid ester, sorbitol hexapalmitate, dulcitol hexamonodecanoic acid ester, dulcitol hexapalmitate, mannitol hexastearate, mannitol hexamyristate and mannitol hexalaurate; acrylate and methacrylate esters having a total of about 14 to about 32 carbon atoms, such as n-decyl methacrylate, n-butyldecyl acrylate, isooctadecyl methacrylate, eicosylpropacrylate, 2,6-diethyleicosylacrylate, n-hexatricontylmethand the like; and dialkyl amides having about 8 to about 28 carbon atoms, such as N,N-diethyl dodecamide, N,N-dimethyl lauramide, N,N-dimethyl stearamide, and the like.

Suitable plasticizers include, for example, phosphate plasticizers such as dibutyl phthalate, triphenyl phosphate, trixylyl phosphate, tert-butylphenyl diphenyl phosphate, and the like; oligomeric and polymeric plasticizers having dihydric phenol units linked via oxalate, iminated carbonate or thionated carbonate linkages such as those described in U.S. Pat. Nos. 4,104,231 and 4,108,820 to Mark et al., where representative dihydric phenols include 2,2-bis(4-hydroxyphenyl)propane (bisphenol A), 1,1-bis(4-hydroxyphenyl)ethane, bis(4-hydroxyphenyl)methane, 2,2-bis(4-hydroxy-3-methylphenyl)propane, 4,4-bis(4-hydroxyphenyl)heptane, 2,2-(3,5,3′,5′-tetrachloro-4,4′-dihydroxydiphenyl) propane), 2,2-(3,5,3′,5′-tetrabromo-4,4′-dihydroxydiphenyl)propane, (3,3′-dichloro-4,4′-dihydroxydiphenyl)methane, and the like; urethane plasticizers such as those described in U.S. Pat. No. 4,124,413 to Mark et al.; siloxane plasticizers such as those described in U.S. Pat. No. 4,148,773 to Mark et al.; and halogen-free organotin plasticizers such as tetradodecylstannane, triphenyl(1-oxododecyloxy)-stannane, tripropyl(1 -oxododecyloxy)stannane, di(1 -oxohexadecyloxy)stannane, di(1-oxo-hexadecyloxy)stannane, di(1-oxo-octyloxy) hexabutyldistannoxane, didodecyldibutoxystannane, poly[oxy(dibutyidibutylbis(1-oxododecyloxy)stannane, dibutylbis(2-ethyl-1-oxohexyloxy)stannane, dibutyldibutoxystannane, hexaphenylhexaphenyldistannane, hexaphenyidistannane, and the like; and plasticizer mixtures comprising at least one of the foregoing plasticizers.

Suitable colorants include various pigments and dyes having sufficient thermal stability to withstand polymer processing conditions. Illustrative colorants having good thermal stability include those known under their Color Index numbers as solvent green 3, solvent green 28, solvent red 52, solvent red 111, solvent red 135, solvent red 169, solvent red 179, solvent red 207, disperse red 22, vat red 41, solvent orange 60, solvent orange 63, solvent violet 13, solvent violet 14, solvent violet 50, amino ketone black, solvent black 7, nigrosine dyes, disperse blue 73, solvent blue 97, solvent blue 101, solvent blue 104, solvent blue 138, disperse yellow 160, solvent yellow 84, solvent yellow 93, solvent yellow 98, solvent yellow 163, solvent yellow 160:1, and mixtures comprising at least one of the foregoing colorants.

Suitable blowing agents (also known in the art as foaming agents) include azodicarbonamide, dinitrosopentamethylene tetramethylene tetramine, p,p′-oxy-bis(benzenesulfonyl)-hydrazide, benzene-1,3-disulfonyl hydrazide, azo-bis-(-isobutyronitrile), biuret, urea, dinitrosopentamethylene tetramine, p-toluene sulfonyl semicarbazide, 5-phenyltetrazole, calcium oxalate, trihydrazino-s-triazine, 5-phenyl-3,6-dihydro-1,3,4-oxadiazin-2-one, 3,6-dihydro-5,6-diphenyl-1,3,4-oxadiazin-2-one, and the like.

Effective amounts of additives vary widely, but they are usually present in an amount up to about 50% by weight, based on the weight of the entire polymeric composition. There is no particular limitation on the manner in which additives are incorporated into the analytical samples. In one embodiment in which the non-biological organic polymer is the same for each of a plurality of samples and the types and amounts of additives are varied, each composition may be prepared by dissolving all components for a given sample in a suitable solvent, then evaporating the solvent to form a homogeneous polymeric composition. Alternatively, the additives for a given composition may be added directly to a solid organic polymer, which is then heated above its melting temperature or glass transition temperature (preferably in an inert atmosphere), allowing diffusion of the additives into the polymer to form a homogeneous composition. In another alternative, the composition may be prepared by delivering additives to a solid organic polymer as an additive solution in a suitable solvent, heating the sample to dissolve the polymer and form a solution, and removing the solvent. Selection of solvents for this purpose is within ordinary skill in the art.

A plurality of analytical samples, each containing the same non-biological organic polymer, may be prepared by utilizing clamping and masking devices to create an array from a continuous polymer film or sheet. Suitable masking devices are described, for example, in U.S. Pat. No. 6,045,671 to Wu et al. Alternatively, the method may utilize a stamping device to cut an array of polymer samples from a single polymer film or sheet. In either case, the additives associated with each composition may then be added as a solid or a solution to form a homogenous composition as described above.

In a preferred embodiment, the method comprises heating the plurality of analytical samples to a temperature of at least about 120° C., preferably of at least about 150° C. Depending on the polymeric composition, temperatures as high as about 315° C. may be used. In this embodiment, known means of sample temperature control may be used to vary the sample temperature in any desired way. For example, the temperature may be rapidly increased from ambient temperature to a temperature above about 120° C. and held substantially constant at the elevated temperature, wherein a substantially constant temperature is defined as a temperature varying less than ±5° C., preferably less than ±2°C. In another example, the sample temperature may be linearly increased from about 25° C. to about 300° C. In another example, the sample temperature may be held constant at a first temperature below the melting temperature (Tₘ) or glass transition temperature (T_{g}) for a first period of time, followed by a second period in which the temperature is increased at least 20° C. to a value above Tₘ or T_{g}, with chemiluminescent detection occurring during the second period of time. In another example, the temperature may be increased exponentially toward an upper limit according to the formula

T=T₀+(e^{rt}−1)

where T is the instantaneous temperature in degrees centigrade, T₀ is the initial temperature in degrees centigrade, t is the time in seconds, and r has a value from about 0.001 to about 0.5. Any desired temperature profile may be used, and the temperature profile may utilize cooling as well as heating.

Various methods known in the art may be used for temperature control. For example, temperature control for isothermal exposures may utilize bimetallic elements controlling a power source to a resistive heater. More precise temperature control may be achieved using a commercially available proportional controller (so-called PID controller). The proportional controller may be programmed to provide a desired heating ramp or a ramp-and-hold temperature sequence. An example of a proportional controller is the Digi-Sense Model 89000-10 sold by Cole Parmer Instrument Co. (625 E. Bunker Court, Vernon Hills, Ill. 60061).

In another preferred embodiment, the method comprises exposing the plurality of analytical samples to a controlled atmosphere. The controlled atmosphere may be oxidizing, reducing, or inert. A preferred oxidizing atmosphere comprises molecular oxygen (O₂). Atmospheres having super-ambient oxygen concentrations (that is, oxygen partial pressures greater than 25 kilopascals) may be useful in accelerated aging experiments in which oxidative degradation is an important pathway for decomposition of the polymeric composition. Other gases useful in oxidizing atmospheres include ozone (O₃), which is a component of ground level pollution that may adversely impact the aging properties of polymeric compositions, and nitrogen dioxide (NO₂). Inert atmospheres, such as those consisting essentially of nitrogen, argon, krypton, and the like, and their mixtures, may be useful, for example, for comparison purposes when observing the chemiluminescence of polymeric compositions in the presence and absence of oxygen. The atmosphere may be varied with time. For example, it may be useful to maintain an inert atmosphere while the plurality of analytical samples is heated to a pre-determined temperature, then replace the inert atmosphere with an oxidizing atmosphere. The pressure of the atmosphere, as well as its composition, may be varied. For example, the pressure may be varied between about 10⁻² kilopascals (kPa) and about 10⁴ kPa, preferably about 10⁻³ kPa and about 10³ kPa. In one embodiment, a plurality of analytical samples is maintained at a pressure of at least about 150 kPa.

Means of maintaining a plurality of samples, particularly combinatorial libraries, under a controlled atmosphere, as well as methods of exchanging atmospheres, are well known and described in, for example, U.S. Pat. Nos. 4,350,495 to Broutman et al., and 5,81 8,599 to Plavnik et al.; and L. Zlatkevich and D. J. Burlett, Polymer Degradation and Stability, volume 65, no. 1, pages 53-58 (1999). In another preferred embodiment, the method comprises exposing the plurality of analytical samples to ultraviolet light or visible light or both. Ultraviolet light comprises wavelengths of about 10 nanometers to about 400 nanometers; visible light comprises wavelengths of about 400 nanometers to about 700 nanometers. Suitable wavelengths for exposing the analytical samples to ultraviolet light may be about 100 nanometers to about 400 nanometers, preferably about 295 nanometers to about 400 nanometers. When resistance to visible and infrared light is of interest, wavelength of about 400 to about 4,000 nm may be used. It is highly preferred that exposing the plurality of analytical samples to light is temporally separated from the detecting a chemiluminescent characteristic from each of a plurality of analytical samples. Preferably, periods of illumination and chemiluminescence detection are temporally separated. The light exposures are useful, for example, for studying the light stability of polymer compositions that are exposed to sunlight. Suitable exposures for this purpose may be about 10 mJ/m² to about 2,000 mJ/m². Suitable illuminances may be about 10 W/m² to about 200 W/m².The plurality of analytical samples may be irradiated at multiple intervals separated by intervals of chemiluminescence detection.

The temperature, atmosphere composition, atmosphere pressure, and light exposure may be varied independently in any way, as long as light exposure is not concurrent with chemiluminescence detection. Preferred combinations of conditions for sample environmental control and chemiluminescence measurements include: maintaining the plurality of samples at a constant temperature during oxidative exposure and chemiluminescence measurement; heating the plurality of samples through a temperature ramp during oxidative exposure and chemiluminmeasurement; maintaining the plurality of samples at a constant temperature during oxidative exposure, then heating the plurality of samples through a temperature ramp during chemiluminescence measurement; maintaining the plurality of samples at a constant temperature and changing the atmosphere from inert to oxidizing during chemiluminescence measurement; and maintaining the plurality of samples at a constant temperature during multiple periods of light exposure, with chemiluminmeasurement after each period of light exposure.

The method comprises determining a property of the composition comprising a non-biological organic polymer based on the chemiluminescent characteristic. In a preferred embodiment, the property relates to the stability of the composition. For example, the property may relate to the composition's thermal stability, its oxidative stability, or its stability to ultraviolet radiation. The property may be a rank order of the stabilities of the compositions tested. The property may also be a relative stability, calculated as the stability of a test composition relative to the stability of a control composition. The property may also be a predicted stability under actual use conditions. Other properties of interest include color changes, embrittlement, haze generation, ductility changes, and crack formation. Additional information about the relationship between chemiluminescence data and polymer properties may be found in, for example, L Zlatkevich in P. P. Klemchuk, ed., American Chemical Society Symposium Series no. 280, “Polymer Stabilization and Degradation”, pages 387-409 (1985).

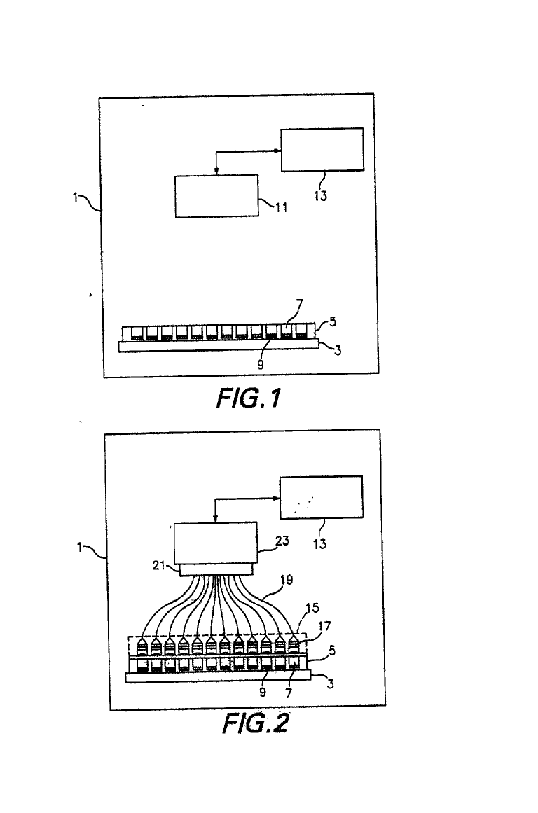

A schematic representation of the apparatus is provided in FIG. 1. The apparatus 1 comprises a temperature controller 3 for manipulating the temperature of a sample array 5 of analytical samples 7 each comprising a polymeric composition 9, a detector 11 for detecting chemiluminescence from the sample array 5, and a computer 13 for determining a property of the composition based on the detected chemiluminescence and optionally for responsively controlling the detector 11. In the preferred embodiment illustrated schematically in FIG. 2, the apparatus 1 comprises a temperature controller 3 for manipulating the temperature of a sample array 5 of analytical samples 7 each comprising a polymeric composition 9, a fiber-coupling lens array 15 comprising at least one lens 17 for collecting and focusing light from the individual samples 7, a plurality of optical fibers 19 operably coupling the fiber-coupling lens array 15 to the fiber array-detector interface 21, which operably couples each optical fiber 19 to a unique region of an array detector 23, and a computer 13 for determining a property of the composition based on the detected chemiluminescence and optionally for responsively controlling the array detector 23.

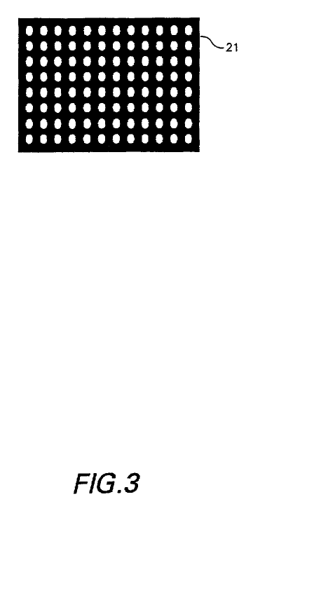

FIG. 3 is a top view of a fiber array-detector interface 21 for a 96 sample array.

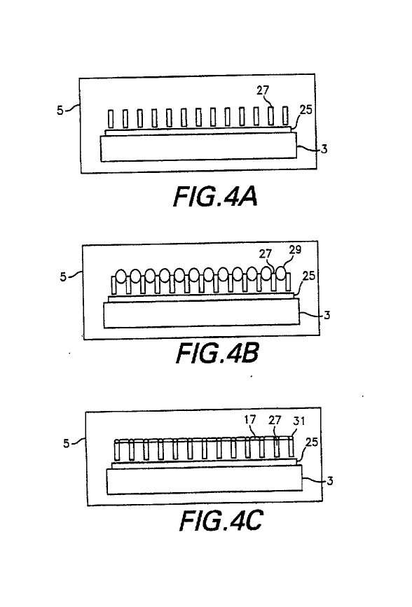

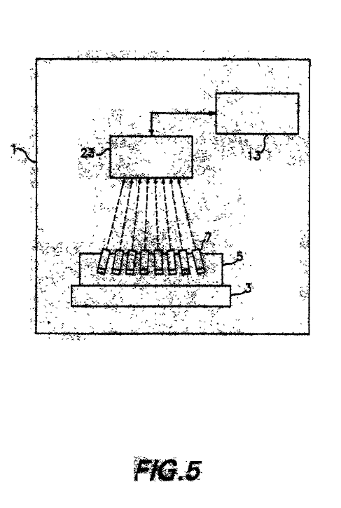

FIG. 4 schematically illustrates three embodiments of a sample array 5 comprising a continuous polymeric film 25. FIG. 4a is a cross-sectional view of a sample array 5 comprising a continuous polymeric film 25 and a temperature controller 3; partitions 27 separate the individual analytical samples 7. FIG. 4b is a cross-sectional view of a sample array 5 comprising the components described for FIG. 4a, and, in addition, a plurality of ball lenses 29 to collect and focus light from each of the analytical samples 7. FIG. 4c is a cross-sectional view of a sample array 5 comprising the components described for FIG. 4a, and, in addition, a plurality of lenses 17 integral to a sample array cover 31.

FIG. 5 is a cross-sectional view of an analytical system 1 comprising a sample array 5, a detector 23, and a computer 13; the sample array 5 comprises a plurality of analytical samples 7, each sample being oriented to direct emitted light toward a unique region of array detector 23.

The invention is further illustrated by the following non-limiting examples.

EXAMPLE 1A glass 96-well array plate with flat bottom wells (part number 07-1500, MicroLiter Analytical Supplies, Inc., Suwanee, Ga. 30024) is metallized using electroless plating followed by electroplating to provide a reflective opaque coating of gold on all surfaces of the wells. The plate is cleaned and dried and 16.5 milligram discs (6.37 mm diameter and 0.63 mm thickness) of unstabilized polypropylene cut from polypropylene film are manually placed in each well. A robotic dispenser is used to dispense xylene solutions containing the stabilizers under evaluation. Stabilizers used include IRGAFOS® 168 (Ciba-Geigy), PEP-Q (Ciba-Geigy), ULTRANOX® 626 (General Electric) and IRGANOX® 1010 (Ciba-Geigy). The compositions for seven stabilizer formulations are (1) IRGAFOS® 168 alone, (2) IRGAFOS® 168+IRGANOX® 1010, (3) PEP-Q alone, (4) PEP-Q+IRGANOX® 1010, (5) ULTRANOX® 626 alone, (6) ULTRANOX® 626+IRGANOX® 1010, and (7) IRGANOX® 1010 alone. The parent solutions of the individual components are prepared to deliver 0.025, 0.016, 0.008 and 0.004 mg of the chosen stabilizer or mixture to the polymer film. The array diversity is arranged across the 8-row axis with seven stabilizer compositions and one control row that is dosed with solvent only. Each stabilizer composition is dispensed in triplicate with four concentration levels corresponding to 1500 ppm, 1000 ppm, 500 ppm and 250 ppm of each stabilizer component. Thus, a set of wells contains, for example, 1000 ppm IRGAFOS® 168 and the next set of rows contains 1000 ppm IRGAFOS® 168+1000 ppm of IRGANOX® 1010 across the 12 column locations. The array is capped with a TEFLON® faced rubber septum, heated to 130° C. in an inert atmosphere with a platen providing sealing pressure to the TEFLON® 169 faced rubber septum. After 20 minutes the apparatus is cooled to room temperature, the septum is removed and the solvent is evaporated under reduced pressure. The resulting cast films of polypropylene and polypropylene with incorporated stabilizers are then placed on a controlled temperature support in an atmosphere-controlled dark chamber fitted with a cooled CCD camera having 250,000 pixels as a 500×500 array with focus at the well bottoms. The temperature of the array is raised to the test temperature of 150° C. while under inert nitrogen atmosphere. A background image is obtained with the CCD camera, and then the atmosphere changed to oxygen. At intervals of 10 minutes exposures of as long as 5 minutes are collected using the CCD camera until all array elements have displayed a peak in their chemiluminescence signal. The pixel data corresponding to each well position are framed to remove well edge effects and the summed or average intensity of the remaining pixels for each well is plotted vs. time. The time to onset or time to peak of light emission is used to characterize the oxidative stability of the polymer compound. Longer times to onset or to peak emission intensity are indicative of more robust stabilizer compositions.

While preferred embodiments have been shown and described, various modifications and substitutions may be made thereto without departing from the spirit and scope of the invention. Accordingly, it is to be understood that the present invention has been described by way of illustration and not limitation.

All cited patents and other references are incorporated herein by reference.

1. An analysis method, comprising:
detecting a chemiluminescent characteristic from each of a plurality of analytical samples, wherein at least one of the analytical samples comprises a composition comprising a non-biological organic polymer; and
determining a property of the composition based on the chemiluminescent characteristic.

2. The method of claim 1, wherein the chemiluminescent characteristic is selected from the group consisting of time to detectable light output, time to peak light output, magnitude of peak light output, best-fit slope of light output versus time, and integrated area of light output versus time.

3. The method of claim 1, wherein the chemiluminescence characteristics of at least about nine analytical samples are detected simultaneously.

4. The method of claim 1, wherein the chemiluminescence characteristics of substantially all of the analytical samples are detected simultaneously.

5. The method of claim 1, wherein the detecting a chemiluminescent characteristic utilizes a detector selected from the group consisting of charge-coupled devices, charge-injection devices, complementary metal oxide semiconductor devices, photodiode arrays, and photodetector arrays.

6. The method of claim 1, wherein the detecting a chemiluminescent characteristic utilizes a detector comprising an avalanche photodiode.

7. The method of claim 1, wherein the detecting a chemiluminescent characteristic utilizes a detector comprising a photomultiplier tube.

8. The method of claim 1, wherein the detecting a chemiluminescent characteristic utilizes a detector comprising a silver halide photographic film.

9. The method of claim 1, wherein the detecting a chemiluminescent characteristic utilizes a detector comprising an array detector.

10. The method of claim 9, wherein the array detector comprises at least about 25 detection sites for each analytical sample.

11. The method of claim 9, wherein the array detector comprises a cooled charge-coupled device.

12. The method of claim 1, wherein the plurality of analytical samples is exposed to a temperature of at least about 120° C.

13. The method of claim 1, wherein the plurality of analytical samples is maintained at a substantially constant temperature of at least about 120° C.

14. The method of claim 1, wherein the plurality of analytical samples is maintained at a substantially constant temperature of at least about 120° C.

15. The method of claim 1, wherein the plurality of analytical samples is exposed to at a first temperature of at least about 25° C. during a first period of time, and exposed to a temperature increase of at least about 20° C. during a second period of time, wherein detecting a chemiluminescent characteristic is performed during the second period of time.

16. The method of claim 1, wherein the plurality of analytical samples is exposed to a temperature range spanning at least about 100° C. during detection a chemiluminescent characteristic.

17. The method of claim 1, wherein the plurality of analytical samples is exposed to a temperature range spanning at least about 100° C., the temperature range comprising a temperature of at least about 120° C.

18. The method of claim 1, wherein the plurality of analytical samples is exposed to an oxidizing atmosphere.

19. The method of claim 18, wherein the oxidizing atmosphere comprises molecular oxygen at a partial pressure greater than 25 kilopascals.

20. The method of claim 1, further comprising replacing an inert atmosphere with an oxidizing atmosphere during the detecting a chemiluminescent characteristic.

21. The method of claim 1, wherein the plurality of analytical samples is maintained at a pressure of at least about 150 kilopascals.

22. The method of claim 1, further comprising exposing the plurality of analytical samples with light exposure of at least about 10 mJ/m², the light comprising a wavelength of about 295 nanometers to about 400 nanometers.

23. The method of claim 1, further comprising irradiating the plurality of analytical samples with light having an illuminance of at least about 10 W/m², the light comprising a wavelength of about 295 nanometers to about 400 nanometers.

24. The method of claim 1, wherein the non-biological organic polymer comprises at least one polymer selected from the group consisting of thermoplastic resins and thermosetting resins.

25. The method of claim 1, wherein the non-biological organic polymer comprises a polymer selected from the group consisting of polyethylene, polypropylene, polyisoprene, polysiloxanes, polyolefins, linear low density polyolefins, acrylate polymers, methacrylate polymers, poly(alkylene oxides) polymers, poly(vinyl chloride), poly(vinylidene chloride), poly (tetrafluoroethylene), polycarbonate resins, polyphenylene ether resins, polyphenylene sulfide resins, poly(alkylene aromatic) resins, vinyl aromatic graft copolymers resins, polyester resins, polyamide resins, polyesteramide resins, polysulfone resins, polyimide resins, polyetherimide resins, styrene copolymers, acrylonitrile butadiene styrene copolymers, poly(ethylenevinylacetate), epoxy resins, phenolic resins, alkyds, allylic resins, polyester thermosetting resins, polyimide thermosetting resins, polyurethane resins, bis-maleimide resins, cyanate ester resins, vinyl resins, benzoxazine resins, benzocyclobutene resins, and mixtures comprising at least one of the foregoing polymers.

26. The method of claim 1, wherein the non-biological organic polymer comprises a polymer selected from the group consisting of polypropylene, polyethylene, ethylene-propylene copolymers, poly(ethylene-vinylacetate), polycarbonates, polyesters, polyamides, polyetherimides, polyphenylene ethers, polyphenylene sulfides, poly(alkylene aromatic) polymers, acrylonitrile butadiene styrene copolymers, acrylic styrene acrylonitrile copolymers, and mixtures comprising at least one of the foregoing polymers.

27. The method of claim 1, wherein the composition additionally comprises an additive selected from the group consisting of antioxidants, stabilizers, ultraviolet light absorbers, fillers, reinforcing agents, flame retardants, mold release agents, and mixtures comprising at least one of the foregoing additives.

28. The method of claim 1, wherein determining a property of the composition based on the chemiluminescent characteristic comprises determining a thermal stability, an oxidative stability, or a light stability.

29. The method of claim 1, further comprising preparing a plurality of analytical samples, wherein at least about 50 percent of the analytical samples comprise a composition comprising a non-biological organic polymer.

30. The method of claim 29, wherein preparing a plurality of analytical samples comprises preparing a solution comprising a non-biological organic polymer.

31. The method of claim 29, wherein preparing a plurality of analytical samples comprises delivering a non-biological organic polymer as a solid to a sample array.

32. The method of claim 31, further comprising delivering at least one additive to the sample array as a solution in a suitable solvent, evaporating the solvent, and heating the sample array to promote diffusion of the at least one additive into the non-biological organic polymer.

33. The method of claim 31, further comprising delivering at least one additive to the sample array as a solution in a suitable solvent, heating the sample array to promote dissolution of the at least one additive and the non-biological organic polymer, and evaporating the solvent.

34. The method of claim 29, wherein the plurality of analytical samples are prepared from a continuous sheet comprising a non-biological organic polymer.

35. The method of claim 1, wherein a sample array comprises the plurality of analytical samples.

36. The method of claim 35, wherein the sample array comprises a plurality of wells comprising opaque walls.

37. The method of claim 35, wherein the sample array comprises a plurality of wells comprising a reflective coating.

38. The method of claim 35, wherein the sample array comprises a plurality of wells comprising a metal coating.

39. The method of claim 35, wherein the sample array comprises a lens array.

40. The method of claim 39, wherein the lens array comprises at least one ball lens.

41. The method of claim 39, wherein at least one optical fiber operably couples the lens array to a chemiluminescence detector.

42. The method of claim 41, wherein the at least one optical fiber comprises a tapered fiber.

43. A method for accelerated stability testing of polymer compositions, comprising:
exposing a plurality of polymeric compositions to at least one environmentally stressful condition; wherein the environmentally stressful condition comprises at least one condition selected from the group consisting of a temperature greater than about 120° C., a light exposure greater than about 10 mJ/m², and an oxygen pressure greater than about 25 kilopascals; and wherein the polymeric composition comprises a non-biological organic polymer;
detecting a chemiluminescent characteristic from each of the plurality of polymeric compositions; and predicting a stability property of each of the plurality of polymeric compositions based on the chemiluminescent characteristic.

44. An analytical system comprising:
a temperature controller for maintaining a plurality of analytical samples at a temperature of at least about 120° C.;
a detector for detecting a chemiluminescent characteristic from each of the plurality of analytical samples; and
a computer for determining a property of the composition based on the chemiluminescent characteristic.

45. An analytical system comprising:
a temperature controller for maintaining a plurality of analytical samples at a temperature of at least about 120° C.;
a cooled CCD detector for detecting a chemiluminescent characteristic from each of the plurality of analytical samples;
a fiber-coupling lens array comprising at least one lens for collecting and focusing light from each analytical sample;
a plurality of optical fibers operably coupled to the fiber-coupling lens array;
a fiber array-detector interface operably coupling each optical fiber to a unique region of the cooled CCD detector; and
a computer for determining a property of the composition based on the detected chemiluminescence and, optionally, for responsively controlling the detector.
